(19) United States
(12) Patent Application Publication
(10) Pub. No.: US 2010/0023490 A1
(43) Pub. Date: Jan. 28, 2010

(54) Method of, and Apparatus for, Controlling the Transportation of Articles, and Arrangement for Transporting a Plurality of Articles

(75) Inventor: Wolf-Stephan Wilke, Konstanz (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, München (DE)

(21) Appl. No.: 12/519,172

(22) PCT Filed: Dec. 14, 2007
(86) PCT No.: PCT/EP2007/063934

§ 371 Date: Aug. 5, 2009

(30) Foreign Application Priority Data
Dec. 14, 2006 (DE) 10 2006 059 525.4

(51) Int. Cl. G06F 7/10; G06F 17/30

(52) U.S. Cl. 707/3; 707/E17.014; 707/100; 707/7

(57) ABSTRACT

A method and apparatus for controlling transportation of a plurality of articles include providing each article with the specification of a destination to which the article is to be transported. Each article passes through a sorting installation at least twice. During both passages through the sorting installation, a respective image of the article is generated. This image includes an image of the destination specification. As the article first passes through the sorting installation, the destination specification is read. This reading result is stored on an interim basis. As the article passes through the sorting installation again, an interim-storage reading result is determined. The reading results control transportation of the articles. A check is made as to whether or not an article has been misdirected. The reasons why an article was misdirected, an incorrect reading result occurred and an incorrect determination of the reading result or transportation error occurred, are established.

The invention relates to a method and an apparatus for controlling the transportation of a plurality of articles and to an arrangement for transporting a plurality of articles. The articles are, in particular, various mailings. The articles pass through a sorting installation at least twice. The first passage involves the respective specification of the delivery point, which has been put on the article, being read. At least one further passage involves this reading result being ascertained.

DE 4000603 C2 proposes ascertaining the reading result during the second passage as follows: each passage involves characteristic features of the article being measured. These are used to ascertain a pattern for the article. The further passage involves the article being identified using these patterns. This results in that reading result which was read during the first passage of this article being ascertained.

EP 1222037 B1 develops the method known from DE 4000603 C2 further. A method is proposed for restricting the search space in which the pattern of the article is sought in order to identify the article.

A method having the features of the preamble of claim 1 and an apparatus having the features of the preamble of claim 10 are known from US 2005/0123170 A1. The articles are shipments which each carry a delivery address. The first passage of a shipment involves production of a depiction of the surface of the shipment, and an identifier for the shipment is generated. This identifier is produced on the basis of the depiction produced for the shipment. The shipment is recognized during a further passage by virtue of a fresh depiction of the shipment being produced and the identifier of the shipment being retrieved, for which purpose the further depiction is evaluated.

The invention considers the possibility of the second passage being taken as a basis for establishing that an article has been misdirected and is not on a transportation path which leads to the delivery point.

The invention is based on the object of providing a method having the features of the preamble of claim 1 and an apparatus having the features of the preamble of claim 10 which monitor the control of the transportation and find the cause of errors in the transportation control.

The object is achieved by a method having the features of claim 1 and an apparatus having the features of claim 10. Advantageous embodiments are specified in the subclaims.

Each article bears a specification for a delivery point to which the article needs to be transported.

The control of the transportation of the articles comprises the following steps:
Each article passes through a sorting installation at least twice.
Both passages involve a respective depiction of the article being produced which comprises a depiction of the delivery point specification.
The first passage of the article involves the delivery point specification being read. This reading result is buffer-stored.
Furthermore, the first passage of the article involves a computer-accessible identifier for the article being generated and buffer-stored. This identifier distinguishes the article from the other articles which are to be transported.
The reading result is taken as a basis for transporting the article by means of the first transportation section.
The further passage of the article through a sorting installation involves a buffer-stored reading result being ascertained. The ascertained reading result was ascertained and buffer-stored during the first passage of an article. With correct transportation control, the reading result which is ascertained during the further passage of an article actually comes from the first passage of this article. However, the method takes account of the possibility of a reading result having been incorrectly ascertained which comes from another article.
Following the further passage, the article is transported by means of a further transportation section, specifically on the basis of the reading result which was ascertained during the further passage.

The method for monitoring this transportation control comprises the following steps:
Both passages involve a respective data record being generated for the article. This data record comprises the depiction of the article produced during the respective passage.
The data record generated for the article during the first passage of each article additionally comprises the generated identifier of the article and the reading result for the article.
The data record generated for the article during the further passage of each article additionally comprises the identifier ascertained for the article.
A check is performed at least once for at least one article to determine whether each transportation section on which the article has already been transported is on a path to the specified delivery point or whether the article has been misdirected.
A checking sequence of steps is performed for the at least one misdirected article.

This sequence comprises the following steps:
The actually specified delivery point for the misdirected article is ascertained.
Data records are ascertained which were generated during a first passage of an article and whose reading results match the delivery point for the misdirected article.
The ascertained data records with a matching reading result are searched for a data record which comprises a depiction of the misdirected article.
   If a data record with a depiction of the misdirected article is found then a search is performed for all data records which were generated during a further passage and whose article identifier matches the article identifier of the data record found.
   If the respective depiction of at least one data record from a further passage which contains the article identifier of the misdirected article does not come from the misdirected article then a message is generated to indicate that the error has occurred in a further passage of another article, that the article identifier ascertained for the other article was the article identifier of the misdirected article.
   If a data record with a depiction of the misdirected article is not found among the ascertained data records with a matching reading result then a message is generated to indicate that the delivery point specification for the misdirected article has been read incorrectly.

The invention monitors the control of the transportation of the articles. It provides a method for finding the cause of an article having been misdirected and therefore transported on an incorrect transportation section which does not lead to the delivery point.

Three groups of causes come into question:
Read errors: the sorting installation identifies the delivery information incorrectly during the first passage of an article, The reading result therefore does not match the delivery point which is actually specified on the article.
Identification errors: the buffer-stored delivery information was not ascertained correctly during a further passage.
Transportation errors: a sorting installation made a mechanical error in the transportation or in the outward transfer during a further passage. Alternatively, the article was transported on a different path than prescribed by the sorting installation.

The invention thus provides a method for measuring quality for the control of the transportation of articles through at least one sorting installation.

The invention eliminates the need to monitor an article during its transportation and to log the transportation sections on which it is transported. This would require an additional measuring device.

The invention is described below with reference to an exemplary embodiment. In this case,

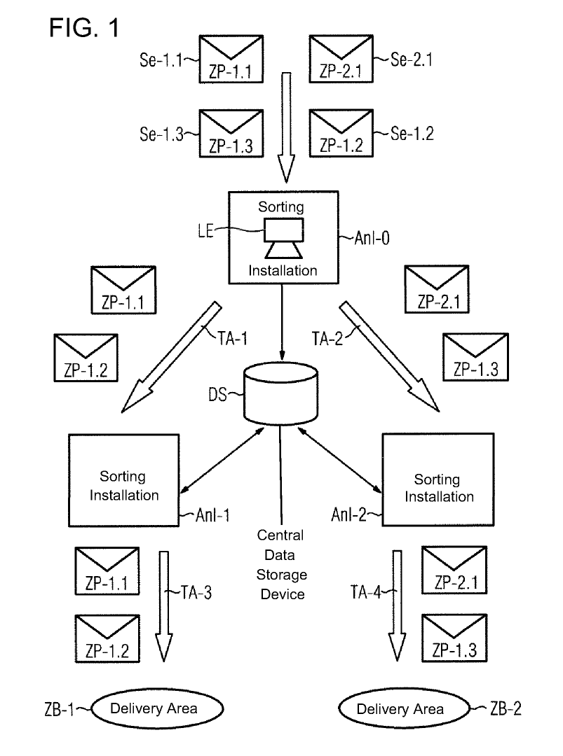

FIG. 1 illustrates the transportation of shipments and the control of this transportation;

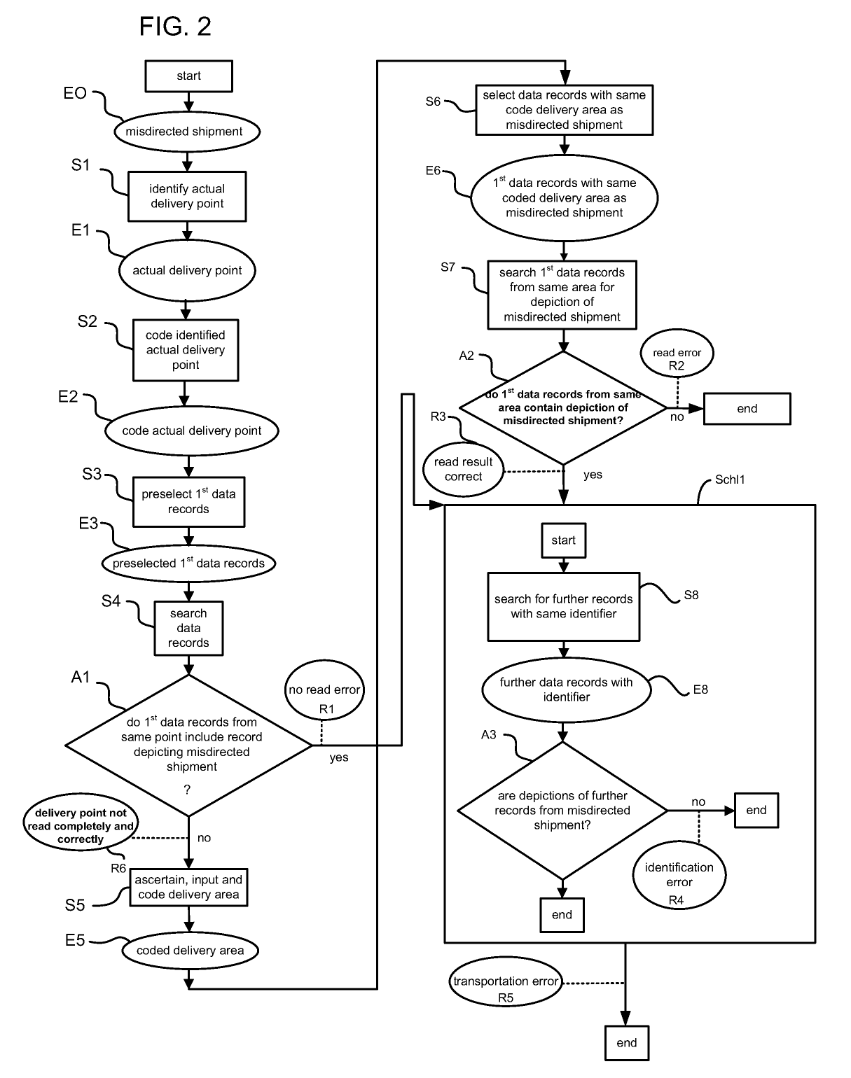

FIG. 2 illustrates the method performed in the exemplary embodiment using a flowchart.

In the exemplary embodiment, the articles to be transported are mailings, e.g. letters and/or packages. The invention can also be applied equally well to other articles for transportation, e.g. baggage from passengers or containers for transportation by sea or land.

In the exemplary embodiment, a mailing, particularly a letter, passes through a sorting installation at least twice on its path from the posting location to the prescribed delivery point. A specification for the delivery point, e.g. the indication of a delivery address, is marked on the shipment. The shipment is posted at a posting location and needs to be transported to this delivery point.

The example in FIG. 1 shows four shipments Se-1.1, Se-1.2, Se-1.3 and Se-2.1. These four shipments need to be transported to the delivery points ZP-1.1, ZP-1.2, ZP-1.3 and ZP-2.1. The delivery points ZP-1.1, ZP-1.2 and ZP-1.3 belong to the delivery area ZB-1, and the delivery point ZP-2.1 belongs to the delivery area ZB-2. Fat arrows show material flows in FIG. 1, and thin arrows show data flows.

During the first passage, the sorting installation attempts to identify the specified delivery point on the shipment. If this is unsuccessful, at least the delivery area which contains the delivery point is identified. The delivery point is, in particular, a particular delivery address, and the delivery area is a particular zip code or a “postal code”. If the sorting installation fails to find a delivery area automatically using “optical character recognition” (OCR), manual video coding then takes place. The manual video coding usually finds only one delivery area.

In the example in FIG. 1, the four shipments first of all pass through the sorting installation Anl-0 when they have been posted. This sorting installation Anl-0 comprises a reading device LE which reads the destinations on the four shipments. The sorting installation Anl-0 produces data records and writes them to a central data storage device DS.

The shipment is then transported by means of a first transportation section, which is dependent on the result of the reading result.

In the example in FIG. 1, the two shipments Se-1.1 and Se-1.2 are first of all transported by means of the transportation section TA-1, which leads to the delivery area ZB-1. The shipments Se-1.3 and Se-2.1 are first of all transported by means of the transportation section TA-2, which leads to the delivery area ZB-2. The shipment Se-1.3 is thus transported by means of an incorrect transportation section, that is to say by means of a transportation section which leads to the delivery area ZB-2 instead of to the correct delivery area ZB-1.

The shipment then passes through a sorting installation again at least once. This sorting installation may be the same or else a different sorting installation as/than during the first passage, depending on where the posting location and the delivery point are situated.

In the example in FIG. 1, the two shipments Se-1.1 and Se-1.2 pass through the sorting installation Anl-1, and the two shipments Se-1.3 and Se-2.1 pass through the sorting installation Anl-2. The sorting installations Anl-1 and Anl-2 have read access to the central data storage device DS. After passageing through Anl-1, the two shipments Se-1.1 and Se-1.2 are transported to the delivery area ZB-1 by means of the further transportation section TA-3. The two shipments Se-1.3 and Se-2.1 are transported to the delivery area ZB-2 by means of the further transportation section TA-4 after passageing through Anl-1.

So that the sorting installation does not need to identify the delivery point for a shipment again during a further passage, the delivery information (delivery point or delivery area) which was identified during the first passage is coded and is buffer-stored in coded form “distribution code”). Each further passage involves the coded and buffer-stored delivery information being automatically ascertained again. The shipment is transported by means of a further transportation section on the basis of the delivery information which was ascertained during the further passage.

Today, the identified delivery information is often coded and buffer-stored by virtue of the sorting installation printing a bar pattern (“bar code”) on the shipment, or putting said bar code on the surface of the shipment in another way, during the first passage. During each further passage, the respective sorting installation reads this bar pattern and determines the further transportation section on the basis of the bar pattern which has been read. Following the further passage, the shipment is transported by means of this further transportation section.

The keyword “fingerprint” denotes a method which avoids or else adds to the printing of a bar pattern on a shipment. During a first passage, the sorting installation scans the surface of the shipment, evaluates the depiction obtained in this manner and generates a feature vector. This feature vector describes properties of the surface, e.g. a distribution of color values and grayscale values. An explicit identifier for the shipment is automatically generated.

The exemplary embodiment uses “fingerprint”. The method can also be used in corresponding fashion in association with printed bar patterns.

For each shipment, the first passage involves a respective first data record being automatically generated and stored in the central data storage device DS. This first data record comprises
the generated identifier (ID) of the shipment,
the coding of the identified delivery information,
a coding for the feature vector (only for “fingerprint”), and
the time at which the data record was generated.

Each further passage in turn involves the surface of the shipment being scanned, and a respective further feature vector is generated.

During the further passage, the previously identified delivery information for the shipment is intended to be ascertained without having to perform fresh OCR recognition.

When fingerprint is used, the further feature vector is compared with feature vectors from previously produced data records. In the exemplary embodiment, each of these earlier data records was generated as or after a shipment passed through a sorting installation for the first time. In the text which follows, data records which were generated during the first passage of a shipment are referred to as first data records. Each of these first data records contains the identifier of the shipment, the coded delivery information and the coded feature vector and also the time of the generation, as has just been illustrated.

To restrict the search space, only selected first data records are used for the comparison. These first data records are stored in the central data storage device DS, to which all sorting installations have read access. The selected data records are searched for that feature vector which is most similar to the further feature vector. The conclusion is automatically drawn that the data record found in this manner for this most similar feature vector comes from the same shipment as the data record from the shipment which is currently to be examined. The coded delivery information for this data record is used as the sought delivery point and stipulates the further transportation section by means of which the shipment is transported after this further passage.

While a shipment is being transported and no earlier than after the second passage, a check is performed at least once to determine whether the shipment has hitherto been transported on correct transportation sections. “Correct” means: on transportation sections which are situated on a transportation path from the posting location to the delivery point for the shipment. In particular, a deliverer needing to transport a quantity of shipments to their respective delivery points checks whether he reaches each of these delivery points on his delivery route or his delivery journey or whether a shipment needs to be transported to a delivery point outside of the delivery route and has therefore been incorrectly given to the deliverer for delivery. This is checked by the deliverer when he is assembling the shipments for his next delivery route/delivery journey, for example, or else not until delivery. The deliverer does this by reading the respective delivery point on each shipment in the quantity. If the delivery point for a shipment is not on his delivery route/his delivery journey, an error has occurred during the previous transportation of the shipment. The misdirected and therefore incorrectly transported shipment is on hand and is used for the method.

The exemplary embodiment of the invention provides a method of finding the cause of a shipment having been misdirected and therefore having been transported on an incorrect transportation section which does not lead to the delivery point.

Three groups of causes come into question:
Read errors: the sorting installation identifies the delivery information incorrectly during the first passage of a shipment. The reading result therefore does not match the delivery point which is actually specified on the shipment.
Identification errors: the buffer-stored delivery information was not ascertained correctly during a further passage. In the case of printed bar patterns, the bar pattern has been printed incorrectly or read incorrectly. In the case of fingerprint, the most similar feature vector identified was an incorrect feature vector, that is to say the feature vector for another shipment.
Transportation errors: a sorting installation made a mechanical error in the transportation or in the outward transfer during a further passage. Alternatively, the shipment was transported on a different path than prescribed by the sorting installation.

The invention thus provides a method for measuring quality for the control of the transportation of shipments through at least one sorting installation.

In line with the invention, each further passage of the shipment through a sorting installation also involves a respective data record being created. For the purpose of distinction, that data record which is created during the first passage of a shipment is called the first data record. There are thus first data records and further data records.

This further data record for the shipment, which is generated during the further passage, first of all comprises
coding of the further feature vector, and
the time at which the further data record was generated.

After the bar pattern has been read or the most similar feature vector among the feature vectors of the first data records has been ascertained during the further passage, a piece of delivery information for the shipment is available which was buffer-stored and coded during the first passage. The further data record is complemented by the following data from the first data record:
by the coding of the ascertained delivery information and
by the ascertained identifier of the shipment.

The further data record may contain a copy of the ascertained delivery information and of the identifier or else a reference to the first data record, from which this information comes.

As illustrated above, each data record contains a time stamp, namely a piece of information about the time at which the data record was generated. In one embodiment, this time stamp is used to establish whether or not a data record is a first data record. If a further, earlier data record with the same shipment identifier is found for a data record x, the data record x is not a first but rather a further data record.

In another embodiment, each data record additionally contains an identifier for whether this data record is a first or a further data record. This identification is a single bit, for example. “1” means: first data record. “0” means: further data record.

Each passage of the shipment involves that surface of the shipment being scanned which bears a specification for the delivery point. This produces a respective computer-accessible depiction of the shipment surface. Each passage involves such a depiction being produced afresh. Each data record which is generated during a passage of the shipment is complemented by that depiction of the shipment surface which was produced during this passage. Each data record thus additionally comprises a depiction of the surface.

FIG. 2 illustrates the method carried out in the exemplary embodiment with the aid of a flowchart.

The misdirected shipment—or a depiction of the surface of the shipment with the specification of the delivery point—is on hand (result E0 from FIG. 2). In the example from FIG. 1, Se-1.3 is a misdirected shipment. Upon arrival in the delivery area ZB-2, it is established that Se-1.3 actually needs to be transported to the delivery area 1.

To find the cause, the actual delivery point for the misdirected shipment is identified (step S1) and is then on hand (result E1). This delivery point is coded (step S2). By way of example, a human reads the delivery point and enters it into a computer. The computer produces the coding for the delivery point. It is also possible for the surface of the misdirected shipment to be scanned afresh, for the delivery point to be identified automatically and for a human to check the reading result and to correct it if required. The coding of the delivery point for the misdirected shipment is available in computer-accessible form (result E2).

All data records which have the following properties are preselected automatically (step S3):
The coded delivery points of the data records are the same as the coded delivery point for the misdirected shipment.
The data records are first data records, that is to say were generated during a first passage of a shipment.

Preferably, a quantity of first data records is first of all preselected on the basis of a criterion. By way of example, all first data records which were generated by particular sorting installations in a particular period are preselected. By way of example, these sorting installations are those which handle the shipments from the posting location of the misdirected shipment first. These first data records were generated during a first passage. During this first passage, the sorting installation identified the delivery point for the shipment and stored it in coded form. It is possible that the sorting installation identified the delivery point incompletely or even incorrectly.

The prescribed period starts five days before the time at which the method was performed and ends two days before this time, for example. The start and end of this prescribed period are dependent on customary transportation delay times for shipments and also on the time at which it was discovered that the shipment had been misdirected.

Among the preselected first data records, each data record whose coded delivery point is the same as the coded delivery point for the misdirected shipment is ascertained. Step S3 delivers a set of data records as the result (result E3). The surface of the misdirected shipment is compared with those shipment surface depictions which belong to the selected first data records (step S4). A check is performed to determine whether one of these depictions comes from the misdirected shipment. All first data records which come from the misdirected shipment are ascertained.

Preferably, the depictions are grouped for this purpose. Grouping is effected using a feature which any shipment surface depiction has and which can be ascertained automatically. The feature space (value range of the feature) is divided into classes. All shipment surface depictions whose feature values come into the same class are associated with the same group. By way of example, the feature is a dimension of the shipment or a distribution of shades of gray.

The misdirected shipment is compared with classes of depictions. By way of example, a class of depictions which are similar to the misdirected shipment is first of all selected. The search is continued among the depictions in this class.

The method is continued to two different extents, depending on whether or not at least one depiction which comes from the misdirected shipment has been found among the depictions of the selected first data records (branch A1). First, the case in which the depiction of the misdirected shipment has been found is described (“yes” continuation of A1). It is possible for a plurality of selected data records to contain a respective depiction of the misdirected shipment.

In the first case, a read error is ruled out (result R1). This is because that first data record which comprises the depiction of the misdirected shipment contains the coding of the correct delivery point for the misdirected shipment. The coded delivery point specification for the misdirected shipment matches this coded delivery point from the first data record found.

As mentioned above, each data record comprises an automatically generated identifier for a shipment. This identifier is generated during the first passage of a shipment. Each data record which was generated during a further passage of the shipment is complemented by this identifier in the exemplary embodiment after the shipment has been identified. Each identifier thus comes from the first passage.

For each first data record with the depiction of the misdirected shipment, the loop Schl-1 is performed. Each first data record which contains the depiction of the misdirected shipment also comprises the identifier of the misdirected shipment. The preselected data records are automatically searched for all further data records which comprise the same shipment identifier as the first data record for the misdirected shipment (step S8). These data records were generated during further passages of the misdirected shipment—unless an identification error has occurred. This is because it is also possible for at least one of these data records to have actually been generated during the passage of another shipment and to have been incorrectly associated with the misdirected shipment. Step S8 thus provides all further data records which have the identifier of the misdirected shipment (result E8).

A check is performed to determine whether or not an identification error has occurred in the further passage. To check this, all further data records which contain the identifier of the misdirected shipment are compared with the misdirected shipment (step S9). This involves the depictions of these further data records being compared with the surface of the misdirected shipment.

A check is performed to determine whether the depictions of all further data records found in step S8 actually come from the misdirected shipment (branch A3). If this is the case, it is certain that no identification error has occurred (“yes” continuation of A3). There therefore merely remains the result that a transportation error is present (result R5), that is to say that the sorting installations have worked correctly. A “No identification errors have occurred” message is produced.

By contrast, if a further data record undeniably contains the identifier of the misdirected shipment but the depiction of the data record does not come from the misdirected shipment then there is an identification error (result R4). In the case of a fingerprint method, the feature vector which was produced during the first passage of the misdirected shipment has been incorrectly identified with a feature vector from a depiction of another shipment during a further passage. In the case of a barcode, an incorrect barcode has been printed, or the correctly printed barcode has been read incorrectly. In both cases, the further passage of another shipment has involved this other shipment being incorrectly identified with the misdirected shipment.

It is also possible for the preselected further data records not to include a single data record which comprises the identifier of the misdirected shipment. This is the case particularly when the misdirected shipment has not been able to be identified during the first further passage, that is to say when no data records which come from the misdirected shipment have been found during the first further passage.

In this case, the delivery point information was read afresh during a further passage of the misdirected shipment. The first data records which have the same coded delivery point as the misdirected shipment are searched for a first data record which comes from the misdirected shipment and which was generated during this further passage of the misdirected shipment.

The text below describes the situation in which, among those first data records whose coded delivery point matches the coded delivery point for the misdirected shipment, none is found whose depiction comes from the misdirected shipment (“no” continuation of A1). In this case, it is certain that the delivery point for the misdirected shipment has not been read completely and correctly (result R6).

Allowance is made for the fact that the exact delivery point is not read from every shipment. If the sorting installation does not automatically identify the exact delivery point during the first passage, it attempts to identify at least the delivery area, e.g. a zip code. First of all, the first passage involves an attempt to identify the delivery area automatically. If this is likewise unsuccessful, a depiction of the shipment is supplied to a video coding station. There, a human being identifies the delivery area and inputs his result using an input device. The first data record which is generated for this shipment therefore contains only a coding for the delivery area and not a coding for the delivery point.

In this example, a distinction is drawn between two reading depths, namely delivery point and delivery area. It is also possible for more than two different reading depths to be distinguished, namely delivery point, delivery area and delivery region, for example. By way of example, a town forms a delivery region, the zip codes for a town form various delivery districts in the delivery region, and the delivery addresses for a zip code form various delivery points. Alternatively, the delivery area comprises all delivery points which are served by a particular mailman.

A coarser search is therefore performed if, among the preselected first data records, no data records which have the coded delivery point for the misdirected shipment come from the misdirected shipment itself.

The delivery area for the misdirected shipment is ascertained, input and coded (step S5, delivers result E5). All those first data records whose coded delivery area is the same as the coded delivery area for the misdirected shipment are selected (step S6). These are the data records for all shipments to the same delivery point or to another delivery point in the delivery area for the misdirected shipment. All first data records from shipments to the same delivery area are ascertained (result E6).

The first data records from the same delivery area are searched for a data record which contains a depiction of the misdirected shipment (step S7). A check is performed to determine whether a data record of this kind has been found in step S7 (branch A2). If such a data record is found (“yes” continuation of A2), it is certain that, although the automatic identification during the first passage has identified the delivery point for the misdirected shipment only incompletely (only the delivery area and not the exact delivery point), this coarser reading result was correct (result R3).

If no matching data records are found during the coarser search either, a search is performed for first data records to the same delivery region—provided that three different reading depths are distinguished. If a data record which comes from the misdirected shipment is not found in any search, it is certain that an error has occurred during the automatic reading of the misdirected shipment, i.e. that a read error has occurred (result R2).

If a matching data record is found during the coarser search, the method is continued in the same way as if the matching data record had been found among those first data records which have the same delivery point as the misdirected shipment. Again, a search is thus performed for all further data records which have the same shipment identifier as the first data record for the misdirected shipment.

A check is performed to determine whether all further data records come from the misdirected shipment (branch A3). If a data record does not come from the misdirected shipment when the loop Schl-1 is executed (“no” continuation of A3), there is an identification error (result R4). If all further data records come from the misdirected shipment each time the loop Schl-1 is executed, there is a transportation error (result R5).

A message regarding whether there is a read error, an identification error or a transportation error is produced and output. Preferably, this message comprises a reference to all data records found which come from the first shipment. It is possible for the message to be complemented by a depiction of the shipment surface of the misdirected shipment.

### LIST OF REFERENCE SYMBOLS USED

| Reference symbol | Meaning |
|---|---|
| A1 | Decision: do the first data records from |
| | the same delivery point include a data |
| | record which contains a depiction of the |
| | misdirected shipment? |
| A2 | Decision: do the first data records from |
| | the same delivery area include a data |
| | record which contains a depiction of the |
| | misdirected shipment? |
| A3 | Decision: do the depictions of all further |
| | data records found in step S8 actually come |
| | from the misdirected shipment? |
| Anl-0, Anl-1, | Sorting installations |
| Anl-2 | |
| DS | Central data storage device |
| E0 | Misdirected shipment |
| E1 | Actual delivery point for the misdirected |
| | shipment |
| E2 | Coding of the actual delivery point for the |
| | misdirected shipment |
| E3 | Preselected first data records whose coded |
| | delivery points are the same as the coded |
| | delivery point for the misdirected shipment |
| E5 | Coded delivery area for the misdirected |
| | shipment |
| E6 | All first data records whose coded delivery |
| | area is the same as the coded delivery area |
| | for the misdirected shipment |
| E8 | All further data records with the |
| | identifier of the misdirected shipment |
| R1 | Result: read error ruled out |
| R2 | Result: read error |
| R3 | Result: although delivery point for the |
| | misdirected shipment identified only |
| | incompletely, read result is correct |
| R4 | Result: identification error |
| R5 | Result: transportation error |
| R6 | Result: delivery point for the misdirected |
| | shipment not read completely and correctly |
| S1 | Identify actual delivery point for the |
| | misdirected shipment |
| S2 | Code identified actual delivery point for |
| | the misdirected shipment |
| S3 | Preselect all first data records whose |
| | coded delivery points are the same as the |
| | coded delivery point for the misdirected |
| | shipment |
| S4 | Search the data records from the same |
| | delivery point for a data record which |
| | contains a depiction of the misdirected |
| | shipment. In doing so, compare the |
| | misdirected shipment with those shipment |
| | surface depictions which belong to the |
| | selected first data records |
| S5 | Ascertain, input and code delivery area for |
| | the misdirected shipment |
| S6 | Select all those first data records whose |
| | coded delivery area is the same as the |
| | coded delivery area for the misdirected |
| | shipment |
| S7 | Search the first data records from the same |
| | delivery area for a data record which |
| | contains a depiction of the misdirected |
| | shipment |
| S8 | Search the preselected data records for all |
| | further data records which comprise the |
| | same shipment identifier as the first data |
| | record from the misdirected shipment |
| Schl 1 | For all first data records with a depiction |
| | of the misdirected shipment: |
| Se-1.1, Se-1.2, | Shipments to the delivery points ZP-1.1, |
| Se-1.3, Se-2.1 | ZP-1.2, ZP-1.3, ZP-2.1 |
| TA-1, TA-2, | Transportation sections |
| TA-3, TA-4 | |
| ZB-1, ZB-2 | Delivery areas |
| ZP-1.1, ZP-1.2, | Delivery points |
| ZP-1.3, ZP-2.1 | |

1-11. (canceled)

12. A method for controlling the transportation of a plurality of articles, the method comprising:
providing each article with a specification for a delivery point to which the article needs to be transported;
passing each article through a sorting installation at least twice;
carrying out a first passage of the article by:
producing a computer-accessible depiction of the article including a depiction of the delivery point specification;
reading the delivery point specification and buffer-storing a reading result; and
generating and buffer-storing an identifier for the article;
transporting the article with a first transportation section based on the reading result;
carrying out the further passage of the article by:
producing a further computer-accessible depiction of the article; and
ascertaining the reading result for an article identifier generated and buffer-stored during a first passage of an article;
evaluating the further article depiction step during the ascertaining step;
transporting the article with a further transportation section based on the ascertained reading result;
carrying out both passes of each article by generating a respective data record for the article including the article depiction produced during the respective passage;
additionally providing the data record generated for the article during the first passage of each article with the generated identifier of the article and the reading result for the article;
additionally providing the data record generated for the article during the further passage of each article with the identifier ascertained for the article;
performing a check at least once for at least one article to determine if each transportation section on which the article has been transported is situated on a path to the specified delivery point or if the article has been misdirected; and
performing the following steps for the at least one misdirected article:
ascertaining the actually specified delivery point for the misdirected article;
ascertaining data records having been generated during the first passage of an article and having reading results matching the actual delivery point for the misdirected article;
searching the ascertained data records with a matching reading result for a data record including a depiction of the misdirected article;
if a data record with a depiction of the misdirected article is found, performing a search for all data records having been generated during a further passage and having an article identifier matching the article identifier of the data record found;
if the respective depiction of at least one data record from a further passage containing the article identifier of the misdirected article does not come from the misdirected article, generating a message to indicate that an error has occurred in a further passage of another article, that the article identifier ascertained for the other article was the article identifier of the misdirected article; and
if a data record with a depiction of the misdirected article is not found among the ascertained data records with a matching reading result, then generating a message to indicate that the delivery point specification for the misdirected article has been read incorrectly.

13. The method according to claim 12, which further comprises:
carrying out each passage of each article by generating a feature vector identifying the depiction of the article produced during this passage;
carrying out the buffer-storage of the identifier and of the reading result during the first passage of an article by buffer-storing the feature vector and a computer-accessible link between the feature vector and the reading result and the identifier; and
carrying out the step of ascertaining the identifier and the reading result in a further passage by:
comparing the feature vector generated during the further passage with feature vectors having been generated in a first passage to determine a prescribed degree of similarity; and
ascertaining an article identifier and a reading result linked to the most similar feature vector.

14. The method according to claim 13, which further comprises:
additionally providing the data record generated for an article during a first passage of the article with the feature vector having been generated during the passage of the article, besides the depiction, the reading result and the identifier; and
carrying out the further passage by ascertaining a data record from a first passage including a similar feature vector.

15. The method according to claim 12, which further comprises:
carrying out the buffer-storage of the identifier and of the reading result during the first passage of an article by:
placing a coding for the identifier on the article; and
including a coding for the reading result in the data record generated for the article during the first passage; and
carrying out the step of ascertaining the identifier and the reading result during a further passage of an article by:
reading the identifier coding having been placed on the article; and
ascertaining a data record from a first passage including the identifier.

16. The method according to claim 12, which further comprises:
in a first step, ascertaining those data records having a reading result being the same as the delivery point specification for the misdirected article as data records having reading results matching the delivery point for the misdirected article; and
searching ascertained data records for a data record including a depiction of the misdirected article; and
if no data record with the depiction of the misdirected article is found in the first step, then using a second step to ascertain those data records having been generated during a first passage and having reading results identifying a delivery area to which the specified delivery point of the misdirected article belongs; and
searching the data records ascertained in the second step for a data record with the depiction of the misdirected article.

17. The method according to claim 12, which further comprises:
carrying out the search for a data record including a depiction of the misdirected article by comparing the article at least once with a depiction belonging to an ascertained data record.

18. The method according to claim 17, which further comprises:
prescribing a feature having a value to be calculated for each depiction of an article;
calculating a value of the feature for each depiction produced during a first passage of an article;
grouping the depictions produced during a first passage of an article using the values for the feature; and
carrying out the search for a data record which includes a depiction of the misdirected article by performing, at least once, the steps of:
selecting a group; and
comparing all depictions in a group with the article.

19. The method according to claim 12, which further comprises:
if the further passage of an article involves no identifier and no reading result being ascertained, then carrying out the further passage by reading the delivery point specification again and producing a further identifier for the article;
additionally providing the data record produced for the article during the further passage with the further reading result;
transporting the article with a further transportation section based on the reading result from the further passage; and
carrying out the step of ascertaining data records having reading results matching the actual delivery point for the misdirected article by additionally ascertaining data records including matching reading results having been attained during the further passage.

20. The method according to claim 12, which further comprises:
passing at least one of the articles through a sorting installation at least three times; and
carrying out each further passage of each article by:
producing a respective further computer-accessible depiction of the article;
ascertaining an article identifier and a reading result from a first passage; and
generating a respective data record including the further depiction and the ascertained identifier.

21. An apparatus for controlling the transportation of a plurality of articles each bearing a specification for a delivery point to which the article needs to be transported, the apparatus comprising:
a sorting installation through which each article passes at least twice;
a first passage of the article involving a computer-accessible depiction of the article being produced including a depiction of the delivery point specification;
the delivery point specification being read and a reading result being buffer-stored; and
an identifier for the article being generated and buffer-stored;
a first transportation section transporting the article based on the reading result;
a further passage of the article involving:
a further computer-accessible depiction of the article being produced; and
an article identifier being generated and buffer-stored during a first passage of an article, and a reading result for the article being ascertained;
the ascertainment including an evaluation of the further article depiction;
a further transportation section transporting the article based on the ascertained reading result;
a logging device configured:
to buffer-store a reading result having been produced by the reading device during the reading of the delivery point specification of an article; and
to generate and buffer-store an identifier for the article; and
to generate, during each passage of an article, a respective data record for the article;
each data record including the article depiction produced during the respective passage;
the data record generated for the article during the first passage of the article additionally including the generated identifier of the article and the reading result for the article; and
the data record generated for the article during the further passage of the article additionally including the identifier ascertained for the article; and
an error ascertainment device configured to perform the following steps for a misdirected article:
ascertaining the actually specified delivery point for the misdirected article;
ascertaining data records having been generated during the first passage of an article and having reading results matching the actual delivery point for the misdirected article;
searching the ascertained data records with a matching reading result for a data record including a depiction of the misdirected article;
if a data record with a depiction of the misdirected article is found, then performing a search for all data records having been generated during a further passage and having an article identifier matching the article identifier of the data record found;
if the respective depiction of at least one data record from a further passage containing the article identifier of the misdirected article does not come from the misdirected article, then generating a message to indicate that the error has occurred in a further passage of another article, that the article identifier ascertained for the other article was the article identifier of the misdirected article; and
if a data record with a depiction of the misdirected article is not found among the ascertained data records with a matching reading result, then generating a message to indicate that the delivery point specification for the misdirected article has been read incorrectly.

22. A configuration for transporting a plurality of articles each bearing a specification for a delivery point to which the article needs to be transported, the configuration comprising:
an apparatus according to claim 21;
a depiction production device for producing a computer-accessible depiction of an article;
a reading device for reading the delivery point specification of an article; and
an identification device for ascertaining a buffer-stored reading result and an article identifier.
